(19) United States
(12) Patent Application Publication
(10) Pub. No.: US 2014/0012642 A1
(43) Pub. Date: Jan. 9, 2014

(54) EVENT-BASED MANAGEMENT OF A COUPON PROMOTION

(71) Applicants: Lisa Seacat DeLuca, San Francisco, CA (US); Lydia M. Do, Raleigh, NC (US); Jenny S. Li, Danbury, CT (US)

(72) Inventors: Lisa Seacat DeLuca, San Francisco, CA (US); Lydia M. Do, Raleigh, NC (US); Jenny S. Li, Danbury, CT (US)

(73) Assignee: INTERNATIONAL BUSINESS MACHINES CORPORATION, Armonk, NY (US)

(21) Appl. No.: 13/540,722

(22) Filed: Jul. 3, 2012

(51) Int. Cl. G06Q 30/02

(52) U.S. Cl. 705/14.5

(57) ABSTRACT

An approach for managing a coupon based on an event is presented. Information about an event is received. Attributes indicating an email or text message communication is from a retailer are received. The communication is received. The communication is determined to be from the retailer and include the coupon by determining the communication has the received attributes. Based on the communication having the attributes, the coupon included in the communication is associated with the event. A user selection of the event is received to display the received information about the event and a link to the communication that includes the coupon associated with the selected event.

### TECHNICAL FIELD

The present invention relates to a data processing method and system for managing offers from merchants, and more particularly to managing a coupon from a retailer based on an event specified by calendaring software.

### BACKGROUND

Merchants send many coupons to users via emails and/or text messages to promote discounts, rebates and other offers related to potential purchases of products and services. Each user manually manages the received coupons. Known online services may send a user alerts about coupons, but the user still manually manages the coupons. The Amazon® Gift Organizer allows a user to track upcoming events and which gifts have been purchased for the tracked events, and may provide suggestions about what gift to give based on a relationship type, price, and/or other attributes. Amazon® Gift Organizer is offered by Amazon.com, Inc. located in Seattle, Wash. A user's Facebook® social network account may be linked to the user's Amazon® e-commerce account, which allows the user to view recommendations provided by the Amazon® account based on the user's interests and activity provided by the Facebook® account. The Facebook® social network is offered by Facebook, Inc., located in Menlo Park, Calif. The linkage between the user's Amazon® and Facebook® accounts may also allow a determination of types of gifts appropriate for the user's friends listed in the user's Facebook® account by (1) searching Amazon® Wish Lists of the friends, or (2) pulling information from Facebook® profiles of the friends.

### BRIEF SUMMARY

In first embodiments, the present invention provides a method of managing a coupon. The method includes a computer receiving information about an event. The method further includes the computer receiving one or more attributes indicating a communication is from a retailer and includes a coupon. The communication is an email or a text message. The method further includes the computer receiving the communication. The method further includes the computer determining the communication is from the retailer and includes the coupon by determining the communication has the one or more attributes. The method further includes, based on the communication having the one or more attributes, the computer associating the coupon included in the communication with the event. The method further includes the computer receiving from a first user a selection of the event. The method further includes, responsive to the step of receiving the selection of the event, the computer initiating a display including at least a part of the received information about the event and a link to the communication including the coupon associated with the selected event.

In second embodiments, the present invention provides a computer system including a central processing unit (CPU), a memory coupled to the CPU, and a computer-readable, tangible storage device coupled to the CPU. The storage device contains instructions that, when carried out by the CPU via the memory, implement a method of managing a coupon. The method includes a computer receiving information about an event. The method further includes the computer receiving one or more attributes indicating a communication is from a retailer and includes a coupon. The communication is an email or a text message. The method further includes the computer receiving the communication. The method further includes the computer determining the communication is from the retailer and includes the coupon by determining the communication has the one or more attributes. The method further includes, based on the communication having the one or more attributes, the computer associating the coupon included in the communication with the event. The method further includes the computer receiving from a first user a selection of the event. The method further includes, responsive to the step of receiving the selection of the event, the computer initiating a display including at least a part of the received information about the event and a link to the communication including the coupon associated with the selected event.

In third embodiments, the present invention provides a computer program product including a computer-readable, tangible storage device and computer-readable program instructions stored in the computer-readable, tangible storage device. The computer-readable program instructions, when carried out by a central processing unit (CPU) of a computer system, implement a method of managing a coupon. The method includes a computer receiving information about an event. The method further includes the computer receiving one or more attributes indicating a communication is from a retailer and includes a coupon. The communication is an email or a text message. The method further includes the computer receiving the communication. The method further includes the computer determining the communication is from the retailer and includes the coupon by determining the communication has the one or more attributes. The method further includes, based on the communication having the one or more attributes, the computer associating the coupon included in the communication with the event. The method further includes the computer receiving from a first user a selection of the event. The method further includes, responsive to the step of receiving the selection of the event, the computer initiating a display including at least a part of the received information about the event and a link to the communication including the coupon associated with the selected event.

In fourth embodiments, the present invention provides a process for supporting computing infrastructure. The process includes providing at least one support service for at least one of creating, integrating, hosting, maintaining, and deploying computer-readable code in a computer system comprising a processor. The processor carries out instructions contained in the code causing the computer system to perform a method of managing a coupon. The method includes a computer receiving information about an event. The method further includes the computer receiving one or more attributes indicating a communication is from a retailer and includes a coupon. The communication is an email or a text message. The method further includes the computer receiving the communication. The method further includes the computer determining the communication is from the retailer and includes the coupon by determining the communication has the one or more attributes. The method further includes, based on the communication having the one or more attributes, the computer associating the coupon included in the communication with the event. The method further includes the computer receiving from a first user a selection of the event. The method further includes, responsive to the step of receiving the selection of the event, the computer initiating a display including at least a part of the received information about the event and a link to the communication including the coupon associated with the selected event.

Embodiments of the present invention tie upcoming events of a user with existing coupons that the user has received. When the user opens an event from a calendar view, the user is able to view the event and the coupons associated with the event.

### BRIEF DESCRIPTION OF THE DRAWINGS

FIG. 1 depicts a block diagram of a system for managing a coupon based on an event, in accordance with embodiments of the present invention.

FIG. 2A is a flowchart of a process of managing a coupon based on an event, where the process is implemented in the system of FIG. 1, in accordance with embodiments of the present invention.

FIG. 2B is a flowchart of a process of updating a display of coupon(s) managed by the process of FIG. 2A, in accordance with embodiments of the present invention.

FIG. 3 is a flowchart of a process that includes event-based management of a coupon received from a social network contact, where the process is implemented in the system of FIG. 1, in accordance with embodiments of the present invention.

FIG. 4 is a flowchart of a process that includes event-based management of a coupon forwarded to a social network contact, where the process is implemented in the system of FIG. 1, in accordance with embodiments of the present invention.

FIG. 5 is a flowchart of a process that includes event-based management of a coupon broadcasted to invitees, where the process is implemented in the system of FIG. 1, in accordance with embodiments of the present invention.

FIG. 6 is an exemplary view of a calendar entry that includes information about an event, a specification of a time period, and attributes indicating a coupon used in the process of FIG. 2A, in accordance with embodiments of the present invention.

FIG. 7 is an exemplary view of a calendar entry that includes the calendar entry information for an event included in FIG. 6 and links to coupons associated with the event displayed in the process of FIG. 2A, in accordance with embodiments of the present invention.

FIG. 8 is a block diagram of a computer system that is included in the system of FIG. 1 and that implements the processes of FIG. 2A, FIG. 3, FIG. 4 and FIG. 5, in accordance with embodiments of the present invention.

### DETAILED DESCRIPTION

### Overview

Embodiments of the present invention automatically associate a user's upcoming events (e.g., mom's birthday, wedding anniversary, son's graduation, etc.) with coupons the user receives prior to the event, where the user and/or other participant(s) in each event are interested in purchasing a product or service for the event. Information about the events may be entered into and stored by a calendar tool (i.e., calendaring software). The user may receive the coupon via an email received by the user or a text message received by the user. The user may receive the coupon included in an email or other message automatically forwarded from a friend or other contact via a social network. Embodiments of the present invention allow the user to view links (i.e., hyperlinks) to the coupons associated with an event as a result of the user opening an event from a calendar entry provided by the calendar tool.

As used herein, a coupon is defined as a ticket, document or code that can be redeemed or otherwise used to obtain a financial reward, discount or rebate for the purchase of a product or service from a retailer, and that is included in, attached to, linked to, or otherwise accessible from an email, text message or other digital message sent via a computer network to a user's computer, mobile device, or other computing device. Coupons include internet coupons, which include coupon codes, promotional codes, promotion codes, discount codes, key codes, promo codes, surplus codes, portable codes, shopping codes, voucher codes, reward codes, discount vouchers, barcode images, Quick Response (QR) codes and source codes that can be entered or scanned in an online checkout to obtain the financial reward, discount or rebate. As used herein, a communication is defined as a digital message that may be an email, a text message, or a short message with embedded picture or digital media.

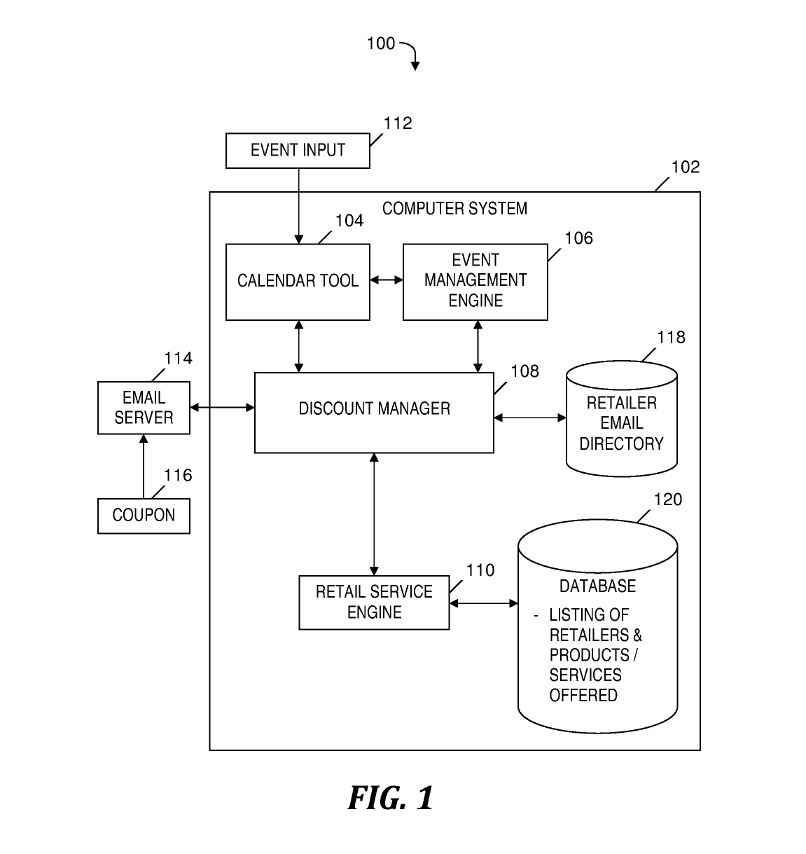

Although the discussions of FIGS. 1-8 presented below describe embodiments in which coupons are received or are otherwise accessible via emails, other embodiments manage coupons that are received or are otherwise accessible via text messages or other forms of messages received by a computer, mobile device or other computer device. Those skilled in the art will understand how text messages or other forms of messages may be substituted for emails in the discussions presented below.

### System for Managing a Coupon Based on an Event

FIG. 1 depicts a block diagram of a system for managing a coupon based on an event, in accordance with embodiments of the present invention. System 100 includes a computer system 102, which runs a calendar tool 104, an event management engine 106, a discount manager 108 and a retail service engine 110. Calendar tool 104, event management engine 106, discount manager 108, and retail service engine 110 are software-based components of computer system 102.

Calendar tool 102 receives an event input 112, which includes information about an event that is entered into calendar tool 102 by a user of computer system 102. The information about the event included in event input 112 includes an identification of the event and a date on which the event begins. Event input 112 may also include a first indication that the user or another participant in the event is interested in purchasing a product or service for the event, a second indication that coupons of interest to the user are to be collected, and/or a third indication that one or more retailers are to be selected or otherwise entered, where a coupon of interest to the user must be for a financial discount, rebate or other reward for a purchase from one of the selected or entered retailer(s).

An email server 114 coupled to computer system 102 via a computer network (not shown) receives a coupon 116 (i.e., a retail offer) by receiving an email (not shown), where coupon 116 is included in, attached to, linked to, or otherwise accessible from the received email. Hereinafter, the received email is also referred to as the email associated with the coupon 116. For example, the email associated with the coupon 116 may be an email sent by a retailer to the user.

Although not shown in FIG. 1, in one embodiment, system 100 may include another server coupled to computer system 102, where the other server sends and receives text messages, and receives another coupon included in, attached to, linked to, or otherwise accessible from a text message.

Event management engine 106 manages all events whose information is entered into the calendar tool 104, including each event for which the user and/or another participant in the event is interested in purchasing a product or service (e.g., a birthday gift to be purchased from a retailer). Calendar tool 104 notifies event management engine 106 that an event has been created. In response to the creation of the event, event management engine 106 sends to discount manager 108 a request for any email associated with a coupon of interest to the user, where the email was received within a specified time period, which is based on the starting date of the event (e.g., within a predetermined time window, such as a period of time that starts one month prior to the starting date of the event and ends on the starting date of the event). The specified time period may be a user-configurable period of time or a default period of time.

Discount manager 108 communicates with email server 114 and identifies emails that are sent by retailers. Discount manager 108 stores all emails from retailers in a retailer email directory 118, which is a database local to computer system 102 or a view of the emails from retailers. In an alternate embodiment, discount manager 108 stores summaries of the emails from retailers in retailer email directory 118.

In one embodiment, discount manager 108 receives a list of retailers from retail service engine 110. Retail service engine 110 searches online for coupons based on the user's gift preference defined in the event received by event management engine 106 and saves the result list into a database 120, where the list associates retailers with respective types of products and/or services the retailers offer for sale, and further associates the retailers with links to coupons. Retail service engine 110 selects retailers and associated links to coupons from database 120 if the retailers (or if a type of product or service sold by the retailers) match the user's gift preference for the event. In an alternate embodiment, database 120 may be replaced with another data structure or another organized collection of data that includes the same data and associations discussed herein as being included in database 120.

In another embodiment, discount manager 108 may receive an email from email server 114 and subsequently query retail service engine 110 to determine whether or not a sender of the email is a retailer.

Discount manager 108 may generate different views of retailers' emails by organizing them into different categories, such as “all coupons,” “coupons by upcoming events,” “coupons to be shared with friends,” etc.

In response to receiving the aforementioned request for any email associated with a coupon of interest to the user, discount manager 108 sends to event management engine 106 a summary of coupon(s) collected up to the point of receiving the request. For each coupon collected, the summary may include an identification of the retailer who offered the coupon, the date the associated email was received, and a description of the discount or rebate offered via the coupon.

Retail service engine 110 maintains a listing of retailers and a taxonomy of products and/or services offered by the retailers, where the listing is included in database 120. Email server 114 or discount manager 108 may access the taxonomy to recognize that an incoming email is from a retailer and to categorize the incoming email according to the products and/or services offered by the retailer.

In one embodiment, retailers register their domain names from which their emails originate and retail service engine 110 stores the registered retailers in the listing in database 120 along with products and/or services offered by the registered retailers.

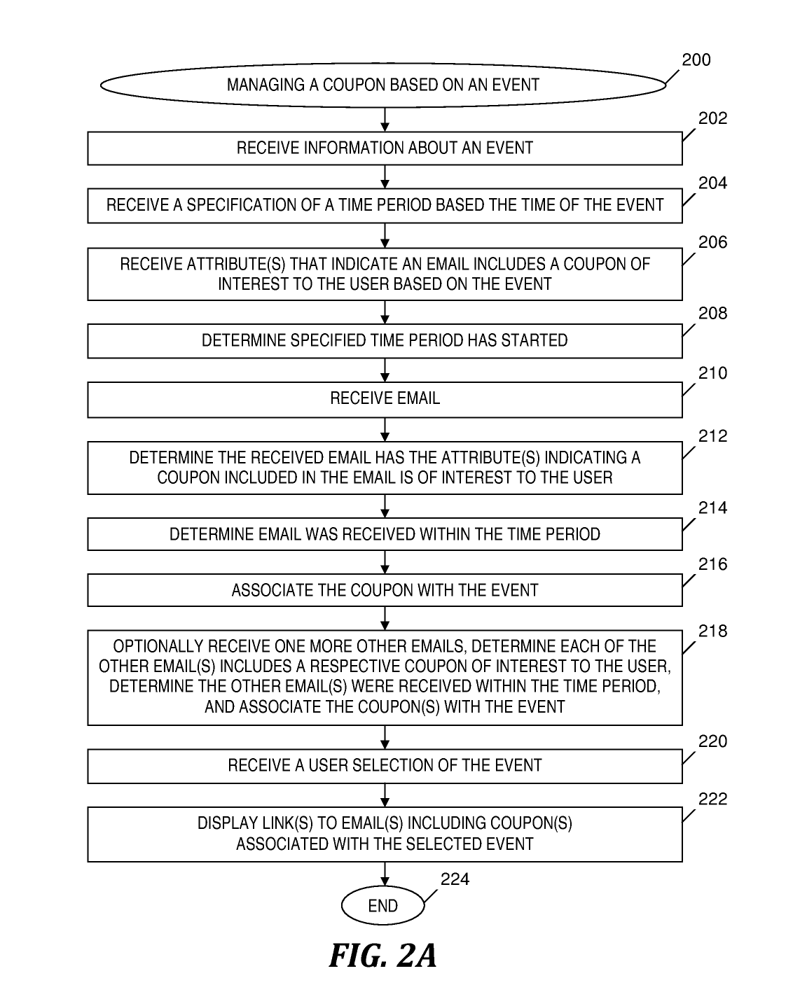

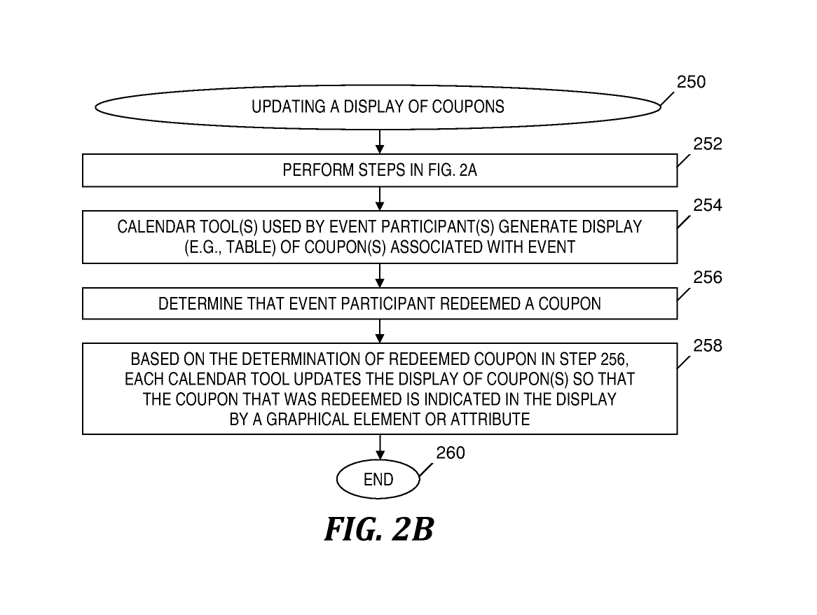

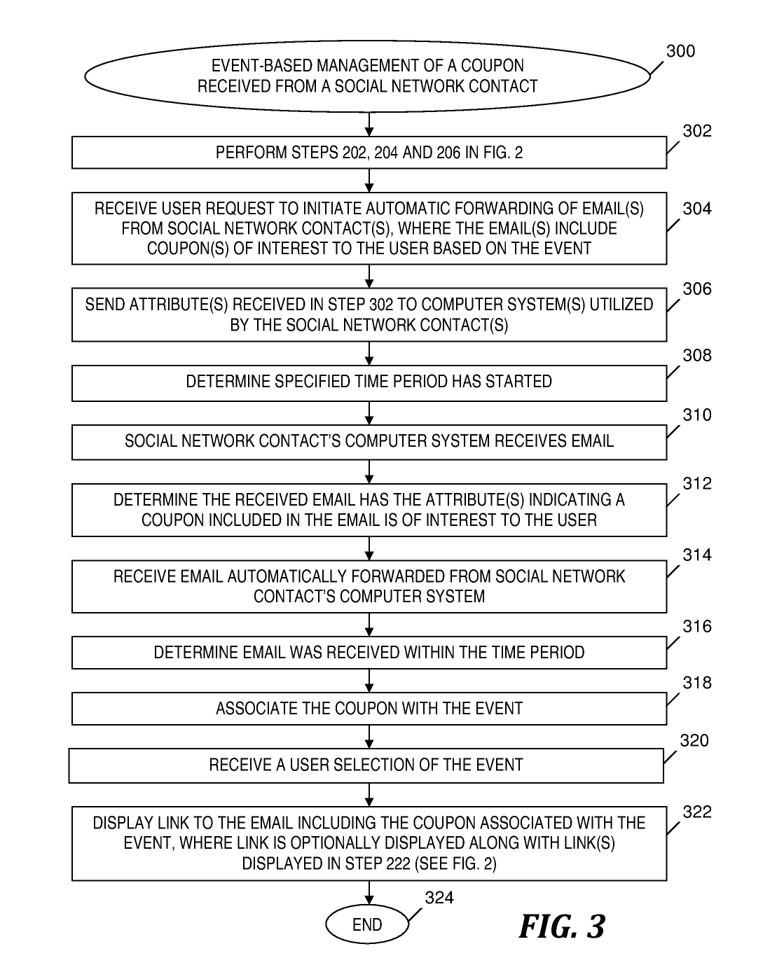

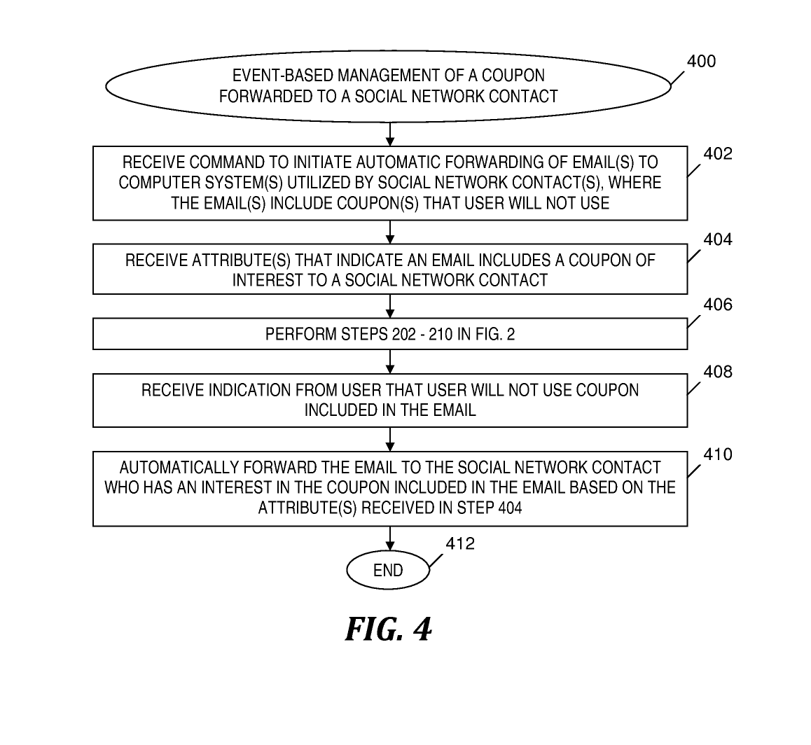

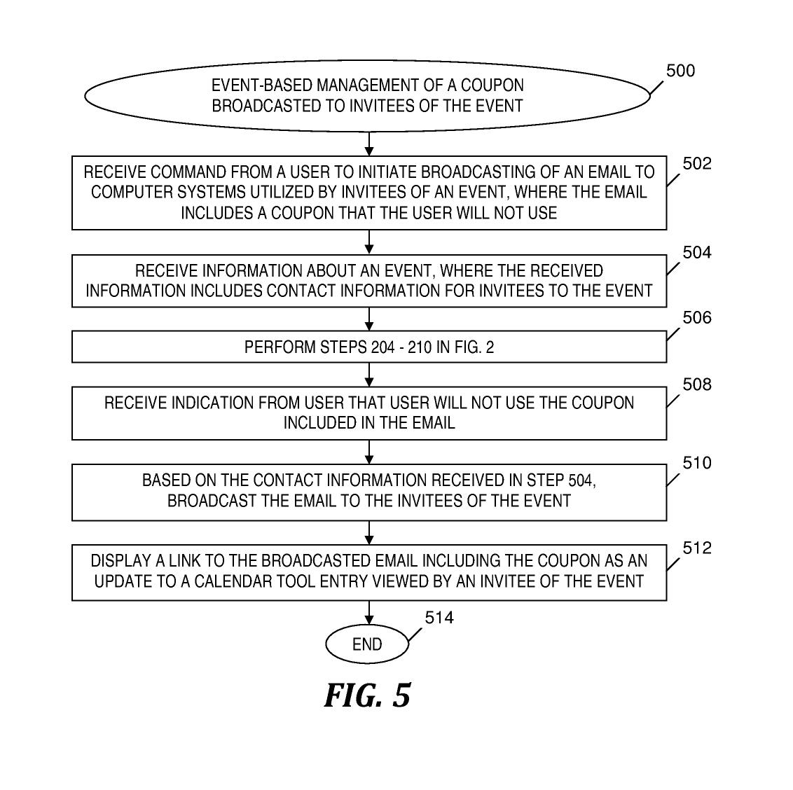

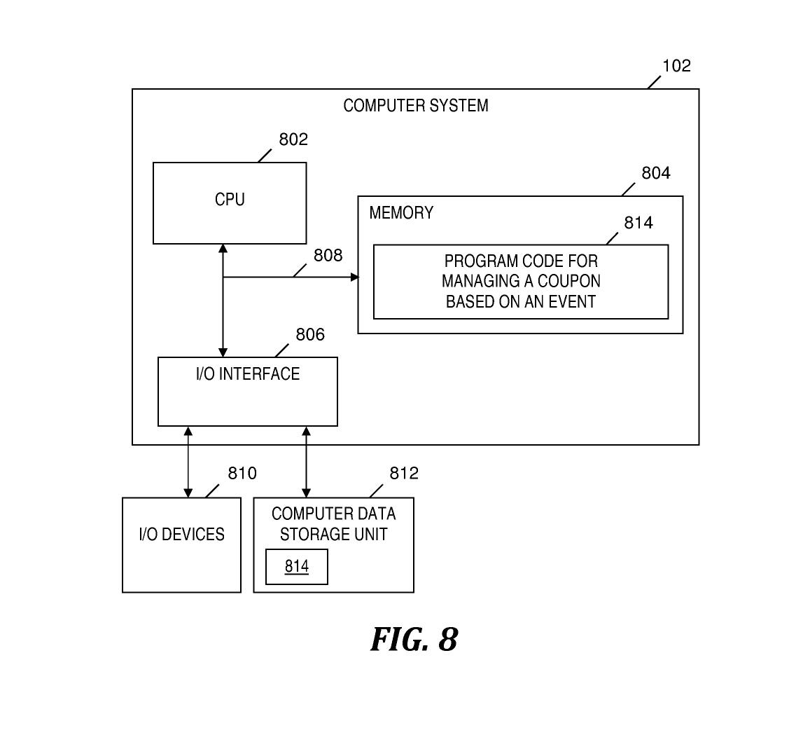

The functionality of the components shown in FIG. 1 is described in more detail in the discussions of FIG. 2A, FIG. 3, FIG. 4, FIG. 5 and FIG. 8 presented below.

### Process for Managing a Coupon Based on an Event

FIG. 2A is a flowchart of a process of managing a coupon based on an event, where the process is implemented in the system of FIG. 1, in accordance with embodiments of the present invention. The process of managing a coupon begins at step 200. In step 202, calendar tool 112 (see FIG. 1) receives information about an event from a user. The received information includes an indication that the event participants may be interested in making a purchase from a retailer of a product or service and that coupons of interest to the user based on the event are to be collected by computer system 102 (see FIG. 1). Hereinafter, the event whose information is received in step 202 is also referred to simply as “the event.” The received information also includes a date on which the event starts. Calendar tool 104 (see FIG. 1) sends the information received in step 202 to event management engine 106 (see FIG. 1).

In step 204, event management engine 106 receives or determines a specification of a time period (also known as (a.k.a.) the “specified time period”) based on the date on which the event starts. The specification of the time period may be a default amount of time or a user-configurable amount of time. For example, step 204 may include receiving a default specification of a one-month time period that immediately precedes the starting date of the event, where the default specification is determined or received by computer system 102 (see FIG. 1). As another example, step 204 may include receiving a user selection of a three week time period that starts four weeks prior to the starting date of the event and ends one week prior to the starting date of the event.

In step 206, discount manager 108 (see FIG. 1) receives attribute(s) that indicate an email includes a coupon of interest to the user based on the event. The received attribute(s) may include identifier(s) of retailer(s) whose coupons are to be collected. The identifier(s) of retailer(s) may include domain name(s) of the retailer(s). As used herein, indicating an email includes a coupon is defined as indicating (1) the coupon is included in the body of the email; (2) the coupon is included in the subject line of the email; (3) the coupon is included in an attachment to the email; (4) a link (i.e., a hyperlink) to the coupon is included in a portion of the email; or (5) a link to the coupon is included in an attachment to the email.

In step 208, event management engine 106 (see FIG. 1) determines that the specified time period has started. Following step 208 and prior to step 210, computer system 102 (see FIG. 1) initiates a collection of any emails received by email server 114 (see FIG. 1) that include a coupon.

In step 210, discount manager 108 (see FIG. 1) receives an email from email server 114 (see FIG. 1).

In step 212, discount manager 108 (see FIG. 1) determines the email received in step 210 has the attribute(s) received in step 206, thereby indicating the email includes coupon 116 (see FIG. 1) and that coupon 116 (see FIG. 1) is of interest to the user based on the information about the event received in step 202. For example, in step 212, discount manager 108 (see FIG. 1) determines that the email address of the originator of the email received in step 210 includes a domain name that is included in the attribute(s) received in step 206.

In step 214, discount manager 108 (see FIG. 1) determines the email received in step 210 was received within the specified time period.

In step 216, computer system 102 (see FIG. 1) associates the coupon 116 (see FIG. 1) with the event. In one embodiment, in step 216, discount manager 108 (see FIG. 1) stores in a data repository a summary of coupon 116 (see FIG. 1) in association with an entry in calendar tool 104, where the entry specifies the event, and where the data repository is coupled to computer system 102 (see FIG. 1). The aforementioned summary of coupon 116 (see FIG. 1) may include an identification of the retailer who sent the email received in step 210, a date on which the email was received, and a description of the coupon.

In optional step 218, discount manager 108 (see FIG. 1) (1) receives one or more other emails and determines the other email(s) include respective coupon(s) of interest to the user based on the event, (2) determines the other email(s) were received within the specified time period, and (3) associates the coupon(s) included in the other email(s) with the event.

In step 220, calendar tool 104 (see FIG. 1) receives from the user a selection of the event.

In step 222, in response to the selection of the event received in step 220, calendar tool 104 initiates a display of link(s) to the email(s) that include coupon(s) associated with the selected event, where the email(s) were received in step 210 and optional step 218.

The process of FIG. 2A ends at step 224.

FIG. 2B is a flowchart of a process of updating a display of coupon(s) managed by the process of FIG. 2A, in accordance with embodiments of the present invention. The process of updating a display of coupon(s) starts at step 250. In step 252, the process of FIG. 2A is performed.

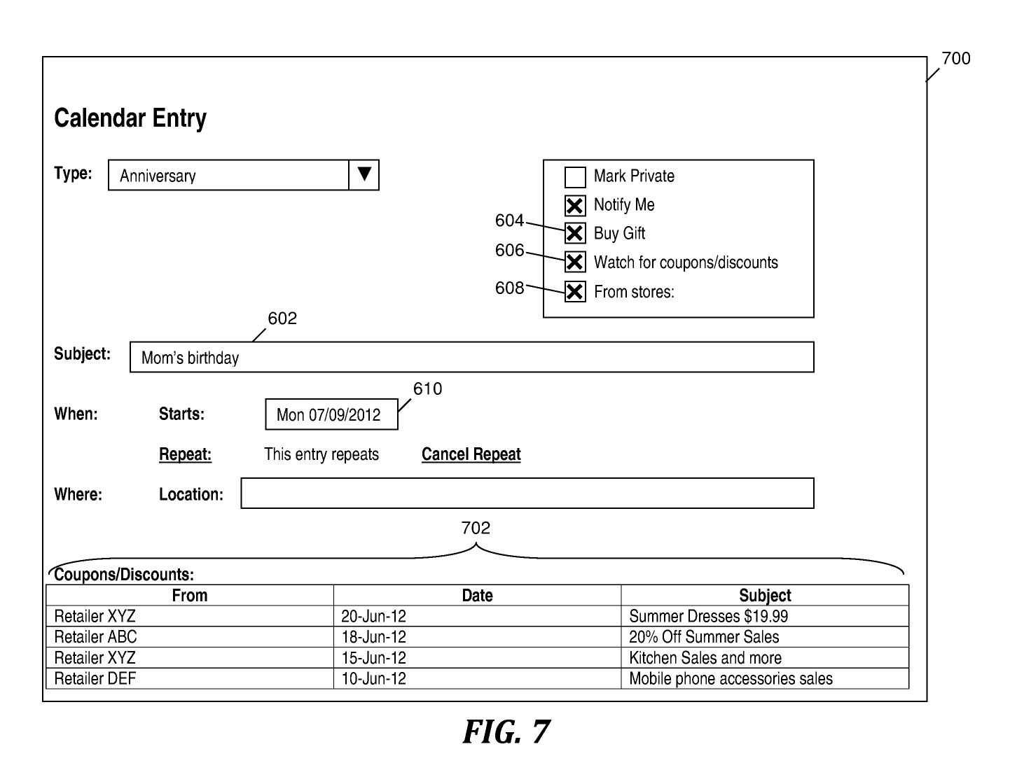

In step 254, calendar tool 104 (see FIG. 1) initiates the generation of a display that includes the coupon(s) associated with the event. Other calendar tool(s) (not shown) included in other computer system(s) (not shown) utilized by other participant(s) of the event may also initiate generation of the same display that includes the aforementioned coupon(s). For example, the calendar tool used by an event participant displays a table that includes information about multiple coupons associated with the event. Summary 702 in FIG. 7 as an example of a table displayed in step 254 that displays information about multiple coupons.

In step 256, computer system 102 (see FIG. 1) determines that an event participant redeemed a coupon included in the display generated in step 254. Alternatively, another computer system (not shown) utilized by another event participant may perform step 256. In one embodiment, determining that an event participant redeemed a coupon in step 256 includes computer system 102 (see FIG. 1) determining that the user of computer system 102 (see FIG. 1) selected a link to a coupon included in the display generated in step 254 and further determining that the user subsequently made selection(s) and/or entry(ies) to redeem the coupon. In another embodiment, determining that an event participant redeemed a coupon in step 256 includes calendar tool 104 (see FIG. 1) receiving an entry by the user of computer system 102 (see FIG. 1) (e.g., receiving the user's entry of a check in a checkbox associated with the coupon) to indicate that the coupon has been redeemed.

In step 258, based on the determination in step 256 that an event participant redeemed a coupon (a.k.a. the “redeemed coupon”), calendar tool 104 (see FIG. 1) and other calendar tool(s) utilized by other event participant(s) update their respective displays previously generated in step 254 so that the redeemed coupon is tagged, highlighted, or otherwise indicated by a graphical element or graphical attribute of the display. Although not shown, steps 256 and 258 may be repeated for one or more other coupons so that the most recent updated display in step 258 includes indications of multiple coupons that have been redeemed. Each event participant may view the indication(s) in the updated display provided by the calendar tool to determine what coupon(s) have been redeemed by other event participant(s). The process of FIG. 2B ends at step 260.

Event-Based Management of a Coupon Received from a Social Network Contact

FIG. 3 is a flowchart of a process that includes event-based management of a coupon received from a social network contact, where the process is implemented in the system of FIG. 1, in accordance with embodiments of the present invention. The event-based management of a coupon received from a social network contact starts at step 300. Although the discussion of FIG. 3 describes a social network contact, embodiments of the present invention may substitute a member of a group for the social network contact, where the user who initiates the automatic forwarding of email(s) is also included in the group. In step 302, computer system 102 (see FIG. 1) performs steps 202, 204 and 206 in FIG. 2A.

In step 304, computer system 102 (see FIG. 1) receives a request from the user to initiate an automatic forwarding of email(s) from social network contact(s), where the email(s) include coupon(s) of interest to the user based on the event.

In step 306, computer system 102 (see FIG. 1) sends the attribute(s) received in step 302 to computer system(s) utilized by the social network contact(s).

In step 308, computer system 102 (see FIG. 1) determines the specified time period has started.

In step 310, a computer system utilized by one of the aforementioned social network contact(s) receives an email.

In step 312, the computer system that received the email in step 310 determines that the received email has the attribute(s) sent in step 306, where having the attribute(s) indicates that a coupon is included in the email and the coupon is of interest to the user. In response to determining the email has the attribute(s), the computer system that received the email in step 310 automatically forwards the email to computer system 102 (see FIG. 1).

In step 314, computer system 102 (see FIG. 1) receives the email automatically forwarded from the computer system that received the email in step 310.

In step 316, computer system 102 (see FIG. 1) determines the email received in step 314 was received within the specified time period.

In step 318, computer system 102 (see FIG. 1) associates the coupon included in the email with the event.

In step 320, computer system 102 (see FIG. 1) receives a user selection of the event by a user interface provided by calendar tool 104 (see FIG. 1).

In step 322, computer system 102 (see FIG. 1) initiates a display of a link to the email that includes the coupon associated with the event. In one embodiment, the display initiated in step 322 also includes the link(s) to one or more other emails that were displayed in step 222 (see FIG. 2A).

### Event-Based Management of a Coupon Forwarded to a Social Network Contact

FIG. 4 is a flowchart of a process that includes event-based management of a coupon forwarded to a social network contact, where the process is implemented in the system of FIG. 1, in accordance with embodiments of the present invention. The event-based management of a coupon forwarded to a social network contact starts at step 400. Although the discussion of FIG. 4 describes a social network contact, embodiments of the present invention may substitute a member of a group for the social network contact, where the user who initiates the automatic forwarding of email(s) is also included in the group. In step 402, computer system 102 (see FIG. 1) receives a command from the user to initiate an automatic forwarding of email(s) to computer system(s) utilized by social network contact(s) of the user, where the email(s) include coupon(s) that the user will not use.

In step 404, computer system 102 (see FIG. 1) receives attribute(s) that indicate an email includes a coupon of interest to one of the aforementioned social network contact(s).

In step 406, computer system 102 (see FIG. 1) performs steps 202-210 in FIG. 2A.

In step 408, computer system 102 (see FIG. 1) receives an indication from the user that the user will not use the coupon included in the email received in step 406.

In step 410, computer system 102 (see FIG. 1) automatically forwards the email received in step 406 to the social network contact who has an interest in the coupon included in the email based on the attribute(s) received in step 404.

The process of FIG. 4 ends at step 412.

### Event-Based Management of a Coupon Broadcasted to Invitees

FIG. 5 is a flowchart of a process that includes event-based management of a coupon broadcasted to invitees, where the process is implemented in the system of FIG. 1, in accordance with embodiments of the present invention. The event-based management of a coupon broadcasted to invitees of an event starts at step 500. In step 502, computer system 102 (see FIG. 1) receives a command from the user to initiate broadcasting of an email to computer systems utilized by invitees of an event, where the email includes a coupon that the user will not use.

In step 504, computer system 102 (see FIG. 1) receives information about an event. The received information includes an indication that the event participants may be interested in making a purchase from a retailer of a product or service and that coupons of interest to the user based on the event are to be collected by computer system 102 (see FIG. 1). The received information also includes a date on which the event starts and contact information for invitees of the event. In one embodiment, the contact information for the invitees includes email addresses and/or text message addresses.

In step 506, computer system 102 (see FIG. 1) performs steps 204-210 in FIG. 2A.

In step 508, computer system 102 (see FIG. 1) receives an indication from the user that the user will not use the coupon included in the email received in step 506.

In step 510, based on the contact information received in step 504, computer system 102 (see FIG. 1) broadcasts the email received in step 506 to the invitees of the event.

In step 512, a computer system utilized by an invitee of the event initiates a display of a link to the broadcasted email that includes the coupon as an update to a calendar entry provided by a calendar tool running in the computer system utilized by the invitee of the event.

The process of FIG. 5 ends at step 514.

### Calendar Entries

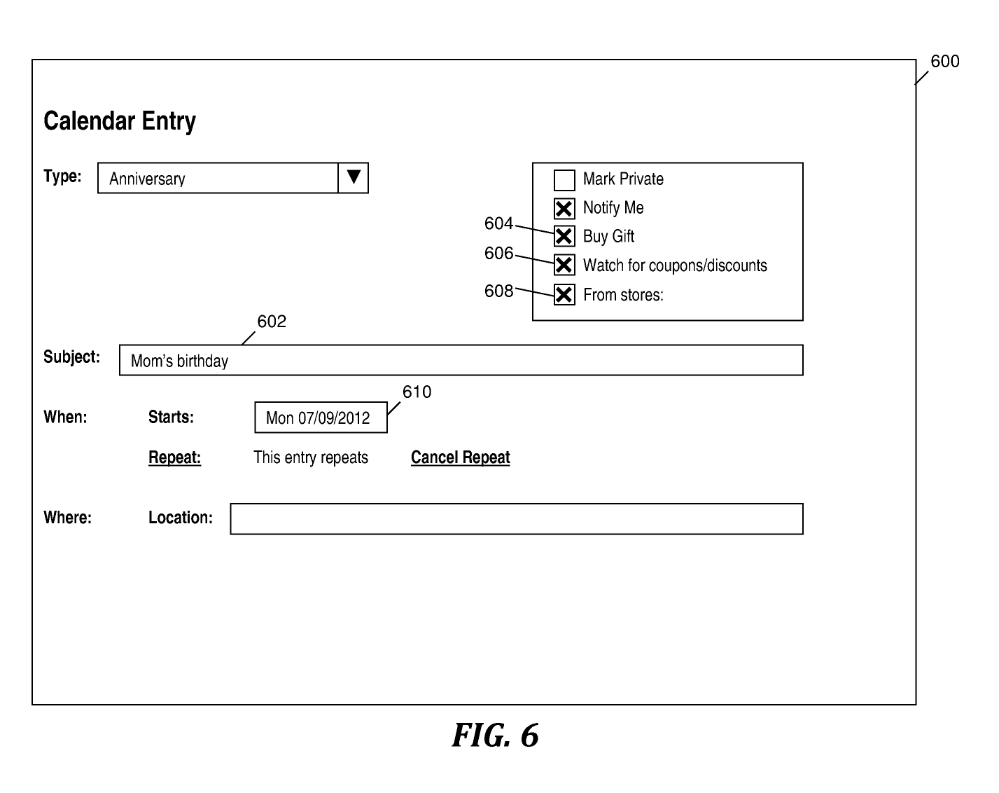

FIG. 6 is an exemplary view of a calendar entry that includes information about an event, a specification of a time period, and attributes indicating a coupon used in the process of FIG. 2A, in accordance with embodiments of the present invention. View 600 is a sample screenshot of a calendar entry that is input into calendar tool 104 (see FIG. 1). View 600 includes a subject 602 that identifies an event being input into calendar tool 104 (see FIG. 1), a first indication 604 that a gift is to be purchased for the event, a second indication 606 that coupons are to be collected for the event, and a third indication 608 that retailers are to be selected from a listing or entered by the user, where the retailers are the potential originators of emails that include coupons that are being collected for the event. Although not shown in FIG. 6, the third indication 608 may cause a display of retailers included in the listing of retailers in database 120 (see FIG. 1) or provide an interface for the user to enter the retailers that may be the potential originators of emails that include coupons. The subject 602 and indicators 604, 606 and 608 are included in the information about the event received in step 202 (see FIG. 2A). View 600 also includes a starting date 610, which indicates the date on which the event starts. Computer system 102 (see FIG. 1) receives the specified time period in step 204 (see FIG. 2A) based on the starting date 610 (e.g., the specified time period is the one month that precedes the starting date 610).

FIG. 7 is an exemplary view of a calendar entry that includes the calendar entry information for an event included in FIG. 6 and links to coupons associated with the event displayed in the process of FIG. 2A, in accordance with embodiments of the present invention. View 700 is a sample screenshot of a calendar entry provided by calendar tool 104 (see FIG. 1). View 700 includes subject 602, indications 604, 606 and 608, and starting date 610, as described above in the discussion of FIG. 6.

View 700 also includes a summary 702 of emails that include coupons associated with the event. Each line of the summary 702 includes an identification of a retailer from which an email originated, the date on which the email was received, and the subject of the coupon included in the email. For each retailer included therein, summary 702 includes a hyperlink (not shown) that, when activated by the user, displays the corresponding email that includes a coupon associated with the event.

Although not shown in FIG. 7, one or more rows of summary 702 may be updated in one or more iterations of step 258 (see FIG. 2B) so that the updated row(s) are highlighted, tagged, or otherwise distinguished from another row by an added graphical element or graphical attribute to indicate that the coupon(s) associated with the respective updated row(s) have been redeemed by an event participant.

### Computer System

FIG. 8 is a block diagram of a computer system that is included in the system of FIG. 1 and that implements the processes of FIG. 2A, FIG. 2B, FIG. 3, FIG. 4 and FIG. 5, in accordance with embodiments of the present invention. Computer system 102 generally comprises a central processing unit (CPU) 802, a memory 804, an input/output (I/O) interface 806, and a bus 808. Further, computer system 102 is coupled to I/O devices 810 and a computer data storage unit 812. CPU 802 performs computation and control functions of computer system 102, including carrying out instructions included in program code 814 to perform a method of managing a coupon based on an event, where the instructions are carried out by CPU 802 via memory 804. CPU 802 may comprise a single processing unit, or be distributed across one or more processing units in one or more locations (e.g., on a client and server). In one embodiment, program code 814 includes code for the calendar tool 104 (see FIG. 1), event management engine 106 (see FIG. 1), discount manager 108 (see FIG. 1) and retail service engine 110 (see FIG. 1) for managing a coupon based on an event.

Memory 804 may comprise any known computer-readable storage medium, which is described below. In one embodiment, cache memory elements of memory 804 provide temporary storage of at least some program code (e.g., program code 814) in order to reduce the number of times code must be retrieved from bulk storage while instructions of the program code are carried out. Moreover, similar to CPU 802, memory 804 may reside at a single physical location, comprising one or more types of data storage, or be distributed across a plurality of physical systems in various forms. Further, memory 804 can include data distributed across, for example, a local area network (LAN) or a wide area network (WAN).

I/O interface 806 comprises any system for exchanging information to or from an external source. I/O devices 810 comprise any known type of external device, including a display device (e.g., monitor), keyboard, mouse, printer, speakers, handheld device, facsimile, etc. Bus 808 provides a communication link between each of the components in computer system 102, and may comprise any type of transmission link, including electrical, optical, wireless, etc.

I/O interface 806 also allows computer system 102 to store information (e.g., data or program instructions such as program code 814) on and retrieve the information from computer data storage unit 812 or another computer data storage unit (not shown). Computer data storage unit 812 may comprise any known computer-readable storage medium, which is described below. For example, computer data storage unit 812 may be a non-volatile data storage device, such as a magnetic disk drive (i.e., hard disk drive) or an optical disc drive (e.g., a CD-ROM drive which receives a CD-ROM disk).

Memory 804 and/or storage unit 812 may store computer program code 814 that includes instructions that are carried out by CPU 802 via memory 804 to manage a coupon based on an event. Although FIG. 8 depicts memory 804 as including program code 814, the present invention contemplates embodiments in which memory 804 does not include all of code 814 simultaneously, but instead at one time includes only a portion of code 814.

Further, memory 804 may include other systems not shown in FIG. 8, such as an operating system (e.g., Linux®) that runs on CPU 802 and provides control of various components within and/or connected to computer system 102. Linux is a registered trademark of Linus Torvalds in the United States, other countries, or both.

Storage unit 812 and/or one or more other computer data storage units (not shown) that are coupled to computer system 102 may store entries to calendar tool 104 (see FIG. 1), retailer email directory 118 (see FIG. 1) and/or the listing of retailers in database 120 (see FIG. 1).

As will be appreciated by one skilled in the art, in a first embodiment, the present invention may be a system; in a second embodiment, the present invention may be a method; and in a third embodiment, the present invention may be a computer program product. A component of an embodiment of the present invention may take the form of an entirely hardware-based component, an entirely software component (including firmware, resident software, micro-code, etc.) or a component combining software and hardware sub-components that may all generally be referred to herein as a “module”.

An embodiment of the present invention may take the form of a computer program product embodied in one or more computer-readable medium(s) (e.g., memory 804 and/or computer data storage unit 812) having computer-readable program code (e.g., program code 814) embodied or stored thereon.

Any combination of one or more computer-readable mediums (e.g., memory 804 and computer data storage unit 812) may be utilized. The computer readable medium may be a computer-readable signal medium or a computer-readable storage medium. In one embodiment, the computer-readable storage medium is a computer-readable storage device or computer-readable storage apparatus. A computer-readable storage medium may be, for example, but not limited to, an electronic, magnetic, optical, electromagnetic, infrared or semiconductor system, apparatus, device or any suitable combination of the foregoing. A non-exhaustive list of more specific examples of the computer-readable storage medium includes: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium is a tangible medium that can contain or store a program (e.g., program 814) for use by or in connection with a system, apparatus, or device for carrying out instructions.

A computer-readable signal medium may include a propagated data signal with computer-readable program code embodied therein, for example, in baseband or as part of a carrier wave. Such a propagated signal may take any of a variety of forms, including, but not limited to, electromagnetic, optical, or any suitable combination thereof. A computer-readable signal medium may be any computer-readable medium that is not a computer-readable storage medium and that can communicate, propagate, or transport a program for use by or in connection with a system, apparatus, or device for carrying out instructions.

Program code (e.g., program code 814) embodied on a computer-readable medium may be transmitted using any appropriate medium, including but not limited to wireless, wireline, optical fiber cable, RF, etc., or any suitable combination of the foregoing.

Computer program code (e.g., program code 814) for carrying out operations for aspects of the present invention may be written in any combination of one or more programming languages, including an object oriented programming language such as Java®, Smalltalk, C++ or the like and conventional procedural programming languages, such as the “C” programming language or similar programming languages. Java and all Java-based trademarks and logos are trademarks or registered trademarks of Oracle and/or its affiliates. Instructions of the program code may be carried out entirely on a user's computer, partly on the user's computer, as a stand-alone software package, partly on the user's computer and partly on a remote computer or entirely on the remote computer or server, where the aforementioned user's computer, remote computer and server may be, for example, computer system 102 or another computer system (not shown) having components analogous to the components of computer system 102 included in FIG. 8. In the latter scenario, the remote computer may be connected to the user's computer through any type of network (not shown), including a LAN or a WAN, or the connection may be made to an external computer (e.g., through the Internet using an Internet Service Provider).

Aspects of the present invention are described herein with reference to flowchart illustrations (e.g., FIG. 2A, FIG. 2B, FIG. 3, FIG. 4 and FIG. 5) and/or block diagrams of methods, apparatus (systems) (e.g., FIG. 1 and FIG. 8), and computer program products according to embodiments of the invention. It will be understood that each block of the flowchart illustrations and/or block diagrams, and combinations of blocks in the flowchart illustrations and/or block diagrams, can be implemented by computer program instructions (e.g., program code 814). These computer program instructions may be provided to one or more hardware processors (e.g., CPU 802) of a general purpose computer, special purpose computer, or other programmable data processing apparatus to produce a machine, such that the instructions, which are carried out via the processor(s) of the computer or other programmable data processing apparatus, create means for implementing the functions/acts specified in the flowcharts and/or block diagram block or blocks.

These computer program instructions may also be stored in a computer-readable medium (e.g., memory 804 or computer data storage unit 812) that can direct a computer (e.g., computer system 102), other programmable data processing apparatus, or other devices to function in a particular manner, such that the instructions (e.g., program 814) stored in the computer-readable medium produce an article of manufacture including instructions which implement the function/act specified in the flowcharts and/or block diagram block or blocks.

The computer program instructions may also be loaded onto a computer (e.g., computer system 102), other programmable data processing apparatus, or other devices to cause a series of operational steps to be performed on the computer, other programmable apparatus, or other devices to produce a computer implemented process such that the instructions (e.g., program 814) which are carried out on the computer, other programmable apparatus, or other devices provide processes for implementing the functions/acts specified in the flowcharts and/or block diagram block or blocks.

Any of the components of an embodiment of the present invention can be deployed, managed, serviced, etc. by a service provider that offers to deploy or integrate computing infrastructure with respect to managing a coupon based on an event. Thus, an embodiment of the present invention discloses a process for supporting computer infrastructure, wherein the process comprises a first computer system providing at least one support service for at least one of integrating, hosting, maintaining and deploying computer-readable code (e.g., program code 814) in a second computer system (e.g., computer system 102) comprising one or more processors (e.g., CPU 802), wherein the processor(s) carry out instructions contained in the code causing the second computer system to manage a coupon based on an event.

In another embodiment, the invention provides a method that performs the process steps of the invention on a subscription, advertising and/or fee basis. That is, a service provider, such as a Solution Integrator, can offer to create, maintain, support, etc. a process of managing a coupon based on an event. In this case, the service provider can create, maintain, support, etc. a computer infrastructure that performs the process steps of the invention for one or more customers. In return, the service provider can receive payment from the customer(s) under a subscription and/or fee agreement, and/or the service provider can receive payment from the sale of advertising content to one or more third parties.

The flowcharts in FIG. 2A, FIG. 2B, FIG. 3, FIG. 4 and FIG. 5 and the block diagrams in FIG. 1 and FIG. 8 illustrate the architecture, functionality, and operation of possible implementations of systems, methods, and computer program products according to various embodiments of the present invention. In this regard, each block in the flowcharts or block diagrams may represent a module, segment, or portion of code (e.g., program code 814), which comprises one or more executable instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method of managing a coupon, the method comprising the steps of:
a computer receiving information about an event;
the computer receiving one or more attributes indicating a communication is from a retailer and includes a coupon, the communication being an email or a text message;
the computer receiving the communication;
the computer determining the communication is from the retailer and includes the coupon by determining the communication has the one or more attributes;
based on the communication having the one or more attributes, the computer associating the coupon included in the communication with the event;
the computer receiving from a first user a selection of the event; and
responsive to the step of receiving the selection of the event, the computer initiating a display including at least a part of the received information about the event and a link to the communication including the coupon associated with the selected event.

2. The method of claim 1, further comprising the steps of:
the computer receiving a specification of a time period based on a starting time of the event; and
the computer determining the communication is received by the computer within the time period, wherein the step of associating the coupon included in the communication with the event is further based on the communication being received by the computer within the time period.

3. The method of claim 1, further comprising the steps of:
the computer receiving a specification of a group that includes the first user and one or more other users, the one or more other users utilizing one or more other computers;
based on the one or more other users and the first user being in the group, the computer initiating an automatic forwarding of communications by the one or more other computers, each communication of the communications having the one or more attributes and being received by a respective computer included in one or more other computers; and
the computer sending the one or more attributes to each computer of the one or more other computers, wherein a result of the step of sending the one or more attributes is a determination by another computer included in the one or more other computers that the communication has the one or more attributes, wherein the automatic forwarding of communications includes an automatic forwarding of the communication by the other computer to the computer, and wherein the step of receiving the communication includes the computer receiving the communication as a result of the automatic forwarding of the communication by the other computer to the computer.

4. The method of claim 1, further comprising the steps of:
the computer receiving a specification of a group that includes the first user and one or more other users, the one or more users utilizing one or more other computers;
based on the one or more other computers and the computer being in the group, the computer initiating an automatic forwarding of communications by the computer to the one or more other computers;
the computer receiving a second one or more attributes indicating a second communication is from a second retailer and includes a second coupon, the second communication being an email or a text message;
the computer receiving the second communication;
the computer determining the second communication is from the second retailer and includes the second coupon by determining the second communication has the second one or more attributes;
the computer receiving an indication the first user is not interested in the second coupon; and
the computer automatically forwarding the second communication to the one or more other computers utilized by the one or more other users included in the group.

5. The method of claim 1, further comprising the steps of:
the computer receiving information about a second event to which the first user and one or more invitees are invited, the information about the second event including contact information for the one or more invitees of the second event;
the computer receiving a second one or more attributes indicating a second communication is from a second retailer and includes a second coupon, the second communication being a second email or a second text message;
the computer receiving the second communication;
the computer determining the second communication is from the second retailer and includes the second coupon by determining the second communication has the second one or more attributes;
the computer receiving a second indication that the first user is not interested in the second coupon included in the second communication; and
based on the second indication that the first user is not interested in the second coupon, the computer broadcasting the second communication to the one or more invitees of the second event by addressing the second communication according to the contact information for the one or more invitees.

6. The method of claim 1, further comprising the steps of:
the computer generating a display including information about one or more coupons associated with the event, the one or more coupons including the coupon;
the computer determining a participant in the event redeemed the coupon; and
in response to the step of determining the participant redeemed the coupon, the computer updating the display by including in the display an indication that the coupon was redeemed.

7. A computer system comprising:
a central processing unit (CPU);
a memory coupled to the CPU;
a computer-readable, tangible storage device coupled to the CPU, the storage device containing instructions that are carried out by the CPU via the memory to implement a method of managing a coupon, the method comprising the steps of:
the computer system receiving information about an event;
the computer system receiving one or more attributes indicating a communication is from a retailer and includes a coupon, the communication being an email or a text message;
the computer system receiving the communication;
the computer system determining the communication is from the retailer and includes the coupon by determining the communication has the one or more attributes;
based on the communication having the one or more attributes, the computer system associating the coupon included in the communication with the event;
the computer system receiving from a first user a selection of the event; and
responsive to the step of receiving the selection of the event, the computer system initiating a display including at least a part of the received information about the event and a link to the communication including the coupon associated with the selected event.

8. The computer system of claim 7, wherein the method further comprises the steps of:
the computer system receiving a specification of a time period based on a starting time of the event; and
the computer system determining the communication is received by the computer system within the time period, wherein the step of associating the coupon included in the communication with the event is further based on the communication being received by the computer system within the time period.

9. The computer system of claim 7, wherein the method further comprises the steps of:
the computer system receiving a specification of a group that includes the first user and one or more other users, the one or more other users utilizing one or more other computer systems;
based on the one or more other users and the first user being in the group, the computer system initiating an automatic forwarding of communications by the one or more other computer systems, each communication of the communications having the one or more attributes and being received by a respective computer system included in one or more other computer systems; and
the computer system sending the one or more attributes to each computer system of the one or more other computer systems, wherein a result of the step of sending the one or more attributes is a determination by another computer system included in the one or more other computer systems that the communication has the one or more attributes, wherein the automatic forwarding of communications includes an automatic forwarding of the communication by the other computer system to the computer system, and wherein the step of receiving the communication includes the computer system receiving the communication as a result of the automatic forwarding of the communication by the other computer system to the computer system.

10. The computer system of claim 7, wherein the method further comprises the steps of:
the computer system receiving a specification of a group that includes the first user and one or more other users, the one or more users utilizing one or more other computer systems;
based on the one or more other computer systems and the computer system being in the group, the computer system initiating an automatic forwarding of communications by the computer system to the one or more other computer systems;
the computer system receiving a second one or more attributes indicating a second communication is from a second retailer and includes a second coupon, the second communication being an email or a text message;
the computer system receiving the second communication;
the computer system determining the second communication is from the second retailer and includes the second coupon by determining the second communication has the second one or more attributes;
the computer system receiving an indication the first user is not interested in the second coupon; and
the computer system automatically forwarding the second communication to the one or more other computer systems utilized by the one or more other users included in the group.

11. The computer system of claim 7, wherein the method further comprises the steps of:
the computer system receiving information about a second event to which the first user and one or more invitees are invited, the information about the second event including contact information for the one or more invitees of the second event;
the computer system receiving a second one or more attributes indicating a second communication is from a second retailer and includes a second coupon, the second communication being a second email or a second text message;
the computer system receiving the second communication;
the computer system determining the second communication is from the second retailer and includes the second coupon by determining the second communication has the second one or more attributes;
the computer system receiving a second indication that the first user is not interested in the second coupon included in the second communication; and
based on the second indication that the first user is not interested in the second coupon, the computer system broadcasting the second communication to the one or more invitees of the second event by addressing the second communication according to the contact information for the one or more invitees.

12. The computer system of claim 7, wherein the method further comprises the steps of:
the computer system generating a display including information about one or more coupons associated with the event, the one or more coupons including the coupon;
the computer system determining a participant in the event redeemed the coupon; and
in response to the step of determining the participant redeemed the coupon, the computer system updating the display by including in the display an indication that the coupon was redeemed.

13. A computer program product, comprising:
a computer-readable, tangible storage device; and
a computer-readable program code stored in the computer-readable, tangible storage device, the computer-readable program code containing instructions that are carried out by a central processing unit (CPU) of a computer system to implement a method of managing a coupon, the method comprising the steps of:
the computer system receiving information about an event;
the computer system receiving one or more attributes indicating a communication is from a retailer and includes a coupon, the communication being an email or a text message;
the computer system receiving the communication;
the computer system determining the communication is from the retailer and includes the coupon by determining the communication has the one or more attributes;
based on the communication having the one or more attributes, the computer system associating the coupon included in the communication with the event;
the computer system receiving from a first user a selection of the event; and
responsive to the step of receiving the selection of the event, the computer system initiating a display including at least a part of the received information about the event and a link to the communication including the coupon associated with the selected event.

14. The program product of claim 13, wherein the method further comprises the steps of:
the computer system receiving a specification of a time period based on a starting time of the event; and
the computer system determining the communication is received by the computer system within the time period, wherein the step of associating the coupon included in the communication with the event is further based on the communication being received by the computer system within the time period.

15. The program product of claim 13, wherein the method further comprises the steps of:
the computer system receiving a specification of a group that includes the first user and one or more other users, the one or more other users utilizing one or more other computer systems;
based on the one or more other users and the first user being in the group, the computer system initiating an automatic forwarding of communications by the one or more other computer systems, each communication of the communications having the one or more attributes and being received by a respective computer system included in one or more other computer systems; and
the computer system sending the one or more attributes to each computer system of the one or more other computer systems, wherein a result of the step of sending the one or more attributes is a determination by another computer system included in the one or more other computer systems that the communication has the one or more attributes, wherein the automatic forwarding of communications includes an automatic forwarding of the communication by the other computer system to the computer system, and wherein the step of receiving the communication includes the computer system receiving the communication as a result of the automatic forwarding of the communication by the other computer system to the computer system.

16. The program product of claim 13, wherein the method further comprises the steps of:
the computer system receiving a specification of a group that includes the first user and one or more other users, the one or more users utilizing one or more other computer systems;
based on the one or more other computer systems and the computer system being in the group, the computer system initiating an automatic forwarding of communications by the computer system to the one or more other computer systems;
the computer system receiving a second one or more attributes indicating a second communication is from a second retailer and includes a second coupon, the second communication being an email or a text message;
the computer system receiving the second communication;
the computer system determining the second communication is from the second retailer and includes the second coupon by determining the second communication has the second one or more attributes;
the computer system receiving an indication the first user is not interested in the second coupon; and
the computer system automatically forwarding the second communication to the one or more other computer systems utilized by the one or more other users included in the group.

17. The program product of claim 13, wherein the method further comprises the steps of:
the computer system receiving information about a second event to which the first user and one or more invitees are invited, the information about the second event including contact information for the one or more invitees of the second event;
the computer system receiving a second one or more attributes indicating a second communication is from a second retailer and includes a second coupon, the second communication being a second email or a second text message;
the computer system receiving the second communication;
the computer system determining the second communication is from the second retailer and includes the second coupon by determining the second communication has the second one or more attributes;
the computer system receiving a second indication that the first user is not interested in the second coupon included in the second communication; and
based on the second indication that the first user is not interested in the second coupon, the computer system broadcasting the second communication to the one or more invitees of the second event by addressing the second communication according to the contact information for the one or more invitees.

18. The program product of claim 13, wherein the method further comprises the steps of:
the computer system generating a display including information about one or more coupons associated with the event, the one or more coupons including the coupon;
the computer system determining a participant in the event redeemed the coupon; and
in response to the step of determining the participant redeemed the coupon, the computer system updating the display by including in the display an indication that the coupon was redeemed.

19. A process for supporting computing infrastructure, the process comprising:
providing at least one support service for at least one of creating, integrating, hosting, maintaining, and deploying computer-readable code in a computer system comprising a processor, wherein the processor carries out instructions contained in the code causing the computer system to perform a method of managing a coupon, the method comprising the steps of:
the computer system receiving information about an event;
the computer system receiving one or more attributes indicating a communication is from a retailer and includes a coupon, the communication being an email or a text message;
the computer system receiving the communication;
the computer system determining the communication is from the retailer and includes the coupon by determining the communication has the one or more attributes;
based on the communication having the one or more attributes, the computer system associating the coupon included in the communication with the event;
the computer system receiving from a first user a selection of the event; and
responsive to the step of receiving the selection of the event, the computer system initiating a display including at least a part of the received information about the event and a link to the communication including the coupon associated with the selected event.

20. The process of claim 19, wherein the method further comprises the steps of:
the computer system receiving a specification of a time period based on a starting time of the event; and
the computer system determining the communication is received by the computer system within the time period, wherein the step of associating the coupon included in the communication with the event is further based on the communication being received by the computer system within the time period.
